(19) United States
(12) Patent Application Publication
(10) Pub. No.: US 2018/0131810 A1
(43) Pub. Date: May 10, 2018

(54) MACHINE LEARNING-BASED CUSTOMER CARE ROUTING

(71) Applicant: T-Mobile, USA, Inc., Bellevue, WA (US)

(72) Inventor: Ryan Yokel, Seattle, WA (US)

(21) Appl. No.: 15/344,293

(22) Filed: Nov. 4, 2016

(51) Int. Cl. H04M 3/523; H04M 3/51; G06N 5/04; G06N 7/00

(52) U.S. Cl. CPC H04M 3/5233; H04M 3/5191; G06N 7/005; G06N 5/048; H04M 3/5183

(57) ABSTRACT

Machine learning-based customer care routing may connect a customer with a support person that has a high level of expertise. A trouble report may be received from a customer of a wireless telecommunication network via on online chat session or a telephone call. A service issue associated with the trouble report may be determined via a machine learning classification algorithm. The trouble report of the service issue may be routed to a support person that is selected from multiple available support persons based on the support person having a higher level of expertise with the service issue than other available support persons. The support person may provide detail edits on the trouble report, such that a problem summary for the service issue may be created. Subsequently, a potential solution for the service issue may be generated based on the problem summary using a machine learning-based recommendation algorithm.

### BACKGROUND

Mobile devices are integral to the daily lives of most users. Mobile devices are used to make voice calls, check email and text messages, update social media pages, stream media, browse websites, and so forth. As a result, users of mobile devices expect a mobile telecommunication carrier to provide constant and reliable telecommunication and data communication services at all times.

The reliability of telecommunication and data communication services may be affected by multiple factors, such as geography and terrain, device features and capabilities, as well as network infrastructure and network coverage deployment. When a customer calls or chats with customer care of wireless telecommunication carrier regarding a service issue, a first available customer service representative may work with the customer to resolve the issue. However, in some instances, such a customer service representative may lack the expertise to resolve the service issue for the customer. Accordingly, the customer service representative may have to route the customer to a different representative of the wireless telecommunication carrier in order to resolve the service issue. In rare instances, the customer may be routed to multiple new representatives in succession until the service issue is resolved. Such policies for handling customer care requests may leave a customer with the impression that the customer service representatives of the carrier are not dedicated to provide high quality customer service, and that customer care is an opaque bureaucratic process that frustrates as much as helps the customer.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for deploying machine learning-based customer care routing to route customers with service issues to support persons of a wireless telecommunication carrier.

FIG. 2 is a block diagram showing various components of one or more illustrative computing devices that implement a support service engine that routes customers with service issues to expert support persons of the wireless telecommunication carrier.

FIG. 3 is a flow diagram of an example process for determining a service issue for a trouble report from a customer and routing the customer to an expert support person.

FIG. 4 is a flow diagram of an example process for increasing or decreasing an expertise rating of an initial support person with respect to a service issue based on the whether the initial support person is able to resolve the service issue for the customer.

FIG. 5 is a flow diagram of an example process for using a machine-learning algorithm in the form of a Bayesian inference graph to determine a root cause of a service issue that is associated with a customer trouble report.

FIG. 6 is a flow diagram of an example process for adjusting the ratings of customers and support persons based on the interactions between the customer and one or more support persons of the wireless telecommunication carrier.

FIG. 7 is a flow diagram of an example process for weighting the detail edits generated by an initial support person for the selection of an escalated support person.

FIG. 8 is a flow diagram of an example process for routing a service issue to an internal support person or an external support person for resolution.

FIG. 9 is a flow diagram of an example process for using the performance of an external support person in resolving service issues to determine a status of the external support person with the wireless telecommunication carrier.

### DETAILED DESCRIPTION

This disclosure is directed to techniques for using machine learning-based algorithms to route the telephone calls or online chat messages of customers with service issues to support persons of a wireless telecommunication carrier with expertise with the service issues. This machine learning-based customer care routing may replace the traditional “one-stop shop” paradigm for providing customer care, in which a frontline customer service representative is expected to deal with different types of service issues. As such, the service issue may range anywhere from an account issue, a retail issue, a device issue, a network issue, a web issue, and/or so forth.

In contrast, the machine learning-based customer care routing may use a machine learning-based routing engine to analyze a trouble report that is received from a customer to determine the specific service issue that is described in the trouble report. The trouble report may contain an indication that service is unsatisfactory to the customer. The trouble report is distinct from the specific service issue or issues, which comprise the specific technical causes of the unsatisfactory service. For example, a trouble report may simply recite that cellular calls are being dropped. The specific service issues may be that the nearest base station is overloaded and/or weather conditions are interfering with cellular coverage. Thus a trouble report may potentially not include the service issue and a trouble report may potentially have more than one service issue associated. Furthermore, a trouble report may contain multiple indications that service is unsatisfactory. The trouble report may be received from the customer via a telephone call or an online chat message. Alternatively, a trouble report may be received from a customer via electronic mail, for which a call or chat to respond to the trouble report is to be initiated by a support person.

Once the routing engine has determined the service issue, the engine may route the trouble report to a support person having particular expertise with the service issue. However, if the routing engine has determined that there are multiple service issues, the engine may route the trouble report to one or more support persons, in which each support person has particular expertise with one or more specific service issues. In various embodiments, the expert support person may be any person working for the wireless telecommunication carrier that is judged by the routing engine as having the requisite expert knowledge to resolve the service issue. For example, the expert support person may not be a customer service representative, but may be a network engineer, an accounts representative, a retail representative working at a physical retail store of the wireless telecommunication carrier, a manager, or another specialist of the wireless telecommunication carrier. Accordingly, the routing engine has the ability to route a customer to a support person of the wireless telecommunication carrier who is determined to be most capable of solving the service issue for the customer, rather to simply to a “one-stop shop” customer care representative.

In various embodiments, the expert support persons that are selected by the machine learning-based routing engine may include internal support persons that are employed by the wireless telecommunication carrier. However, during peak times or other crisis situations, the routing engine may be configured to select external support persons (e.g., third-party vendors, third-party contractors, crowd-sourced experts, etc.) to resolve service issues for the customers.

The machine learning-based routing engine may grade the expertise of the support persons following the support sessions of the support persons with the customers who submitted trouble reports. The support sessions may be conducted via telephone calls or online chat sessions. For example, the routing engine may increase the expertise rating of a support person with respect to a service issue if the support person is able to successfully resolve the service issue for the customer. On the other hand, if the support person is unable to resolve a service issue for a customer, the routing engine may decrease the expertise rating of the support person with respect to the service issue. In this way, the routing engine may accumulate knowledge regarding the expertise of the support persons, such that the routing engine is able to route future trouble reports of customers to available support persons who are mostly likely to solve their service issues.

Accordingly, the use of machine learning-based customer care routing may increase the likelihood that a customer who is experiencing a service issue is assisted by a support person that has specific expertise with the service issue. Further, the use of machine-learning-based customer caring routing may classify the support persons of the wireless telecommunication carrier according to their expertise rather than their other attributes (e.g., physical location, assigned department, etc.). By assigning different experts to resolve service issues that are reported by a customer, the customer is essentially provided with a team of experts that are able to deliver the most suitable assistance to the customer regarding of the nature of the service issues that are encountered by the customer. Thus, the techniques may increase customer satisfaction and customer retention by providing attentive customer care service to the customer. The techniques described herein may be implemented in a number of ways. Example implementations are provided below with reference to the following figures.

### Example Architecture

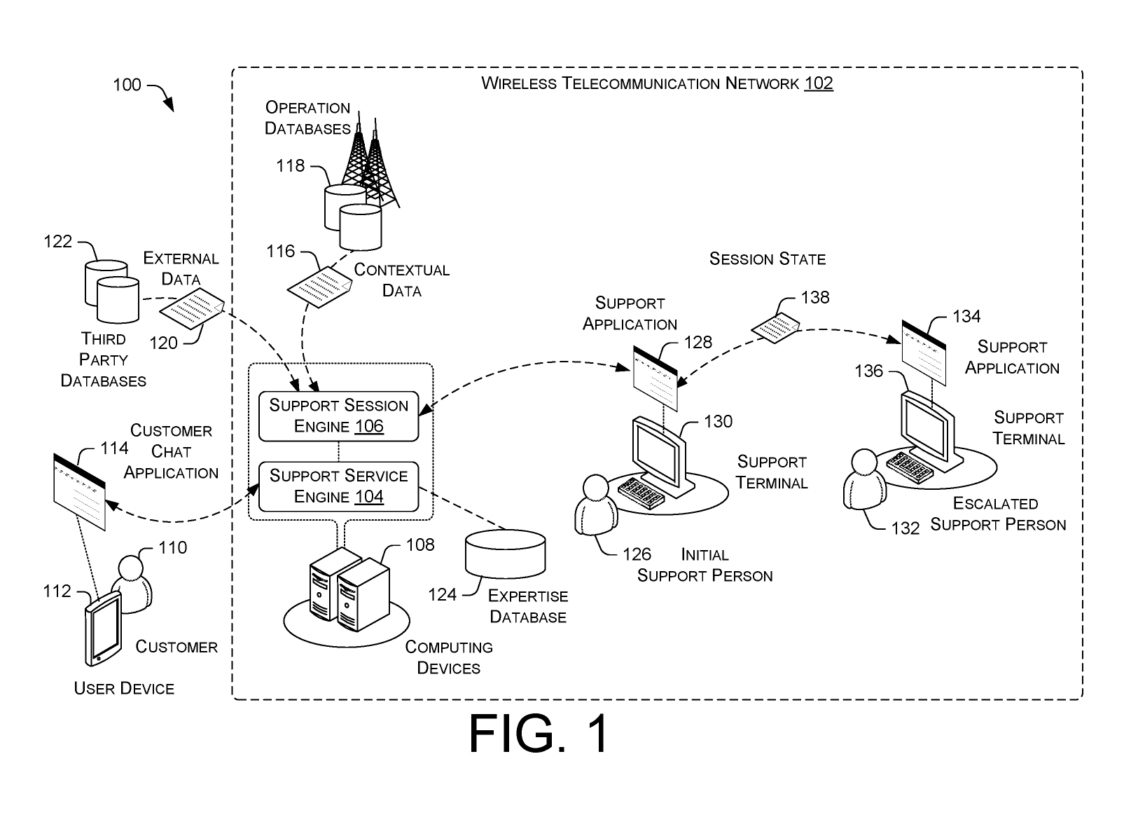

FIG. 1 illustrates an example architecture for deploying machine learning-based customer care routing to route customers with service issues to support persons of a wireless telecommunication carrier. The architecture 100 may include a wireless telecommunication network 102 that is operated by a wireless telecommunication carrier. The wireless telecommunication network 102 may provide a wide range of mobile communication services, as well as ancillary services and features, to subscribers and associated mobile device users. In various embodiments, the wireless telecommunication network 102 may provide wireless communication between multiple user devices. Further, the wireless telecommunication network 102 may also provide communications between the multiple user devices and other user devices that are serviced by other telecommunication networks. In various embodiments, the user devices may include mobile handsets, smart phones, tablet computers, personal digital assistants (PDAs), smart watches, and/or electronic devices.

The wireless telecommunication network 102 may be implemented using multiple interconnected networks. In various embodiments, the wireless telecommunication network 102 may include multiple Radio Access Networks (RANs). The RANs may be connected to each other via regional ground networks. In turn, the regional ground networks may be connected to a core network by a wide area network (WAN). Each regional portion of the wireless telecommunication network 102 may include one or more RANs and a regional circuit and/or packet switched network and associated signaling network facilities.

A RAN of the wireless telecommunication network 102 may include a number of base stations. In some embodiments, the base stations may be in the form of eNodeB nodes. Each eNodeB node may include a base transceiver system (BTS) that communicates via an antennae system over an air-link with one or more user devices that are within range. The BTS may send radio communication signals to user devices and receive radio communication signals from user devices. The radio access networks may carry the communications for the user devices between the respective base stations and the core network. The core network may connect to a public packet data communication network, such as the Internet. Packet communications via the RANs, the core network, and the Internet may support a variety of services through the wireless telecommunication network 102.

The wireless telecommunication network 102 may further include a support service engine 104 and a support session engine 106. Each engine may execute on one or more computing devices 108. The one or more computing devices 108 may include general purpose computers, such as desktop computers, tablet computers, laptop computers, servers, or other electronic devices that are capable of receive inputs, process the inputs, and generate output data. In still other embodiments, the one or more computing devices 108 may be virtual computing devices in the form of computing nodes, such as virtual machines and software containers. In various embodiments, the computing devices 108 may be controlled by a wireless telecommunication carrier that provides the wireless telecommunication network 102, and/or controlled by a third-party entity that is working with the mobile telecommunication carrier.

The support service engine 104 may route incoming telephone calls or online chat session messages with trouble reports to support persons of the wireless telecommunication carrier that are most suited to resolve the trouble reports. The trouble reports may originate from customers, such as the customer 110. The customer 110 may use a user device to place a telephone support call to a customer care phone number of the wireless telecommunication network 102. In turn, the telephone call is intercepted by the support service engine 104. The support service engine 104 may prompt the customer 110 to leave a trouble report in the form of an audio recording that describes a wireless telecommunication service problem encountered by the customer. Alternatively, the customer 110 may use a customer chat application 114 on the user device 112 to initiate a support chat session with the support service engine 104. The customer chat application 114 may be a standalone application or a part of a customer support application that is provided to the customer 110 by the wireless telecommunication carrier. In such a scenario, the support service engine 104 may prompt the customer to provide a trouble report in the form of a text message that describes the wireless telecommunication service problem encountered by the customer.

In turn, the support service engine 104 may use a machine learning classification algorithm to analyze the trouble report provided by the customer to determine an actual service issue encountered by the customer. In various embodiments, the machine learning classification algorithm may match specific words or phrases that the customer used in the trouble report to a specific service issue. In some embodiments, the machine-learning classification algorithm may also use contextual data 116 from the operation database 118 and/or external data 120 from the third-party databases 122 to determine the actual issue encountered by the customer who provided the trouble report.

In various embodiments, the contextual data 116 may include relevant network information, device information, and/or user account information. The network information may include information regarding the technical and operational status of the wireless telecommunication network. For example, network information of the network may indicate that Long-Term Evolution (LTE) spectrum coverage (or other spectrum coverage) is unavailable in a particular geographical area or that a network node was temporarily overwhelmed with network traffic at a particular time due to a major event. The device information of user devices may indicate the technical capabilities, feature settings, and operational statuses of user devices. For example, device information for the user device 112 may indicate that Wi-Fi calling is enabled on the user device or that the user device is capable of using a specific communication band provided by the wireless telecommunication network. In other examples, the device information for the user device 112 may indicate that Wi-Fi calling is disabled on the user device, a developer mode is active on the user device, a location tracking service is active on the user device, and/or so forth. The user account information for a customer may include account details of multiple users, such as account type, billing preferences, service plan subscription, payment history, data consumed, minutes of talk time used, and/or so forth. For example, the account data of the customer 110 may indicate that the user has a postpaid account and that the user is current with payments for the subscribed service plan.

The third-party databases 122 may include databases that are provided by entities other than the wireless telecommunication network 102. For example, a third-party database may be provided by a third-party vendor, a third-party contractor, a government entity, another telecommunication carrier, a social media website, and/or so forth. The external data 120 may be network-related information, device-related information, and/or user-related information that supplement the contextual data 116. In some instances, the external data 120 may include regulatory information for networks and devices, device manufacturer information, credit information on users, and/or so forth.

In other instances, the external data 120 may include relevant social media data. The social media data may be provided by social networking portals. Social media portals may include a portal that is established by the wireless telecommunication carrier, a portal that is maintained by a third-party service provider for users to share social media postings, and/or a portal that is created and maintained by a particular user solely for the particular user to present social postings. The social media portals may be mined by the support service engine 104 for external data that is relevant to the issue that the customer 110 is experiencing with the user device 112 or another user device. For example, social media posting may indicate that a particular geographical area has poor network coverage, a particular model of a user device has below average signal reception, a certain operating system of a user device is prone to a specific software virus, and/or so forth. Accordingly, the support service engine 104 may use a correlation algorithm to correlate the relevant information mined from the social media portals to the customer 110 and/or the user device 112.

Accordingly, the machine learning classification algorithm of the support service engine 104 may use the contextual data 116 and/or the external data 120 in conjunction with the trouble report of a customer to determine a service issue that is experienced by the customer. For example, if the contextual data 116 indicates that a particular network cell proximate to a geolocation of the customer is experiencing service disruptions, and the trouble report from the customer states that “my LTE is not working” the machine learning classification algorithm may determine that the service issue is a lack of network coverage. In another example, if the external data 120 indicates that a web browser on a particular model of user device has stopped working after a software upgrade, and the trouble report from the customer states that “I can't get on the Internet,” the machine learning classification algorithm may determine that the service issue is improper device software configuration.

Following the determination of a service issue that is associated with a trouble report from a customer, the support service engine 104 may route the trouble report of the service issue to a support person of the wireless telecommunication network 102 for handling. The support person may handle the trouble report by engaging in a support telephone call or a support chat session with the customer. The support service engine 104 may select a support person to handle the trouble report of the customer based on information stored in an expertise database 124. In various embodiments, the expertise database 124 may include a list of support persons. Each of the support persons in the list may be assigned a predetermined catalog of multiple service issue items and the expertise ratings of the support person with respect to the service issue items. For example, the predetermined catalog of multiple service issue items may include items such as Android operating system, Android applications, iPhone OS operating system, iPhone OS applications, network cell configuration, account dispute, Android device hardware, iPhone device hardware, retail device exchange, device accessory acquisition, web services configuration, multimedia service configuration, and/or so forth. In some embodiments, the expertise database 124 may also store a current status for each support person. For example, the current status for a support person may indicate whether the person is available to provide support service, is busy providing service to another customer, or is unavailable to provide support service. Accordingly, by using the expertise database 124, the support service engine 104 may select an available support person that has the highest expertise rating with respect to a service issue of the customer to handle the trouble report of the customer.

Once a support person is selected to handle the service issue of a customer, the support service engine 104 may activate the support session engine 106. In turn, the support session engine 106 may inform an initial support person to engage in a support session with the customer 110 via a support application. For example, in instances in which the support session is an online chat session, the initial support person 126 may use a support application 128 to engage in the support session. The support application 128 may be a chat program that reside on the support terminal 130 of the initial support person 126. Alternatively, if the support session is a telephone call, the initial support person may engage in telephonic voice communication with the customer. During the support session, the initial support person 126 may review the trouble report submitted by the customer. The initial support person 126 may also communicate with the customer to obtain additional information from the customer regarding the service issue. In some instances, the initial support person 126 may further use the support application 128 to request contextual data 116 from the operation databases 118 that are relevant to the customer, the device of the customer, or components of the wireless telecommunication network that are relevant to service issue experienced by the customer.

Subsequently, the initial support person 126 may make detail edits to the trouble report of the customer based on the obtained knowledge and/or experience of the initial support person 126. For example, the initial support person 126 may note that the service issue is actually a malfunction of a software component of the user device rather than a malfunction of a hardware component of the user device. In another example, the initial support person 126 may note that the service issue is actually with a network cell rather than the user device. The support service engine 104 may generate a problem summary that includes the details from the trouble report and/or the detail edits.

The problem summary may be further process by the support service engine 104 to surface potential solutions to the service issue. In various embodiments, the support service engine 104 may use a machine learning algorithm to determine a root cause of the service issue. Upon determining the root cause, the support service engine 104 may generate a solution that remedies the root cause from information stored in a solutions database. The root cause and the potential solutions may be surfaced to the initial support person 126. In turn, the initial support person 126 may present the solution to the customer in the support session. In some instances, the solution may successfully remedy the service issue and the support session may be terminated.

However, in instances in which the initial support person 126 indicate that the solution did not the resolve the service issue for the customer, the support service engine 104 may select an escalated support person to join the support session to resolve the service issue for the customer. The initial support person 126 may make such an indication via an application user interface control of the support application 128. As shown in FIG. 1, the escalated support person may be the escalated support person 132 that is using a support application 134 on a support terminal 136. In various embodiments, the escalated support person 132 that is selected by the support service engine 104 may have an expertise rating for the service issue that is equal to or higher than the expertise rating of the initial support person 126 for the service issue.

Following the selection of the escalated support person, the support service engine 104 may activate the support session engine 106 to initiate the support session transition. During the transition, the support session engine 106 may forward the session state information 138 to the support terminal 136 of the escalated support person 132. The escalated support person 132 may use a support application 134 to view the session state information 138. The session state information 138 comprises either the transcript of the session the initial support person 126 had with the customer, a summary of the transcript, or a set of parameters comprising information of the session. In some embodiments, session state information 138 may include transcript and/or information from multiple individual sessions, as well as subsequent detail edits by the escalated support person and/or others. The session state information 138 may further include information from the trouble report, the detail edits, the contextual data 116, the external data 120, and/or so forth.

In instances in which the support session is an online chat session, the escalated support person 132 may use the support application 134 join the initial support person 126 in the chat session. In this way, the escalated support person 132 may seamlessly join the chat session with the customer 110. The escalated support person 132 may assist the customer 110, which may involve the escalated support person 132 making additional detail edits on the trouble report in the problem summary. In some embodiments, the escalated support person 132 may further request an additional support person to be assigned to the service issue if the escalated support person is unable to resolve the service issue. The additional support person may join the chat session in the same manner as the escalated support person 132. In other words, by saving and forwarding the session state information on a repeated basis, the support session engine 106 may support multiple support persons chatting with a customer in a single support chat session. In instances in which the support session is a telephone call, the escalated support person 132 may join the telephone call (e.g., telephone conference) or take over the telephone call (e.g., call transfer).

In various embodiments, each support person that is in a support session may be an internal or an external support person of the wireless telecommunication network 102. An internal support person may be an employee or contractor that works directly for the wireless telecommunication carrier that operates the wireless telecommunication network 102. An external support person may be a third-party vendor, a third-party contractor, a crowd-sourced expert, and/or so forth, that do not work directly for the wireless telecommunication carrier. Each support person may be a located at one of multiple locations. The locations may include a call center of the wireless telecommunication carrier, a physical retail store that is operated by the wireless telecommunication carrier, a remote third-party location, and/or so forth.

The support service engine 104 may also grade the expertise of the support persons that provided support to a customer for a service issue. For example, the support service engine 104 may increase the expertise rating of a support person with respect to a service issue if the support person is able to successfully resolve the service issue for the customer. On the other hand, if the support person is unable to resolve a service issue for a customer, the routing engine may decrease the expertise rating of the support person with respect to the service issue. In this way, the routing engine may accumulate knowledge regarding the expertise of the support persons, such that the routing engine is able to route future trouble reports of customers to available support persons who are mostly likely to solve their service issues. Further, the support service engine 104 may also modify the machine-learning algorithms based on the specific circumstances under which service issues are resolved to generate more accurate root causes and solutions for service issues.

### Example Computing Device Components

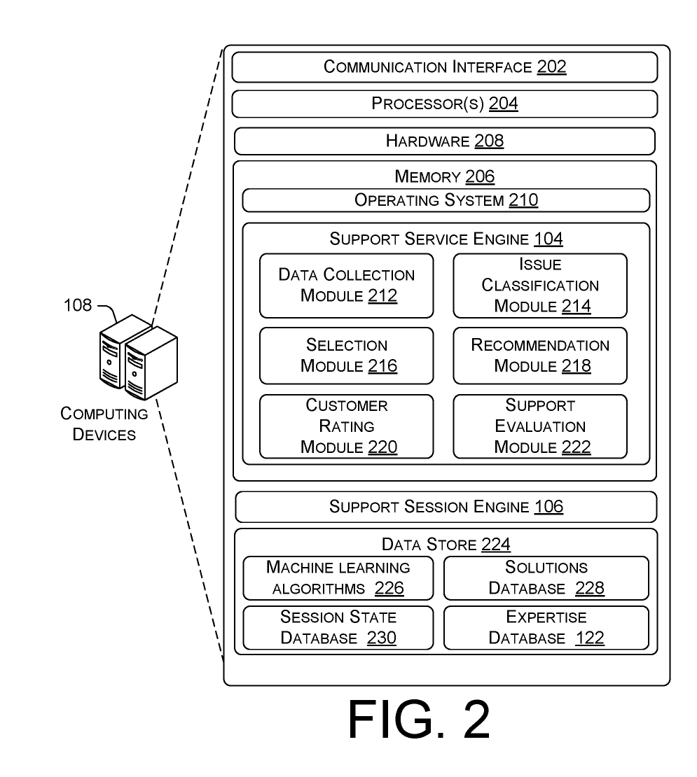

FIG. 2 is a block diagram showing various components of one or more illustrative computing devices that implement a support service engine that routes customers with service issues to expert support persons of the wireless telecommunication carrier. The computing devices 108 may include a communication interface 202, one or more processors 204, memory 206, and hardware 208. The communication interface 202 may include wireless and/or wired communication components that enable the devices to transmit data to and receive data from other networked devices. The hardware 208 may include additional hardware interface, data communication, or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The processors 204 and the memory 206 of the computing devices 108 may implement an operating system 210. In turn, the operating system 210 may provide an execution environment for the support service engine 104 and the support session engine 106. The operating system 210 may include components that enable the computing devices 108 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The support service engine 104 may include a data collection module 212, an issue classification module 214, a selection module 216, a recommendation module 218, a customer rating module 220, and a support evaluation module 222. The modules may include routines, program instructions, objects, and/or data structures that perform particular tasks or implement particular abstract data types. The memory 206 may also include a data store 224 that is used by the support service engine 104.

The data collection module 212 may receive trouble reports from telephone calls or online chat session messages. The telephone calls and the online chat session messages may be routed to the support service engine 104 via a customer communication routing function of the wireless telecommunication network 102. In instances in which a trouble report is from a telephone call, the data collection module 212 may use a speech-to-text engine to generate a text version of the verbal trouble report. However, in instances in which a trouble report is from an online chat session, the data collection module 212 may save the trouble report from the corresponding text message.

The data collection module 212 may retrieve data from the operation databases 118 and the third-party databases 122. In various embodiments, the data collection module 212 may retrieve data that are relevant to a particular user device or customer from the databases. The relevant data for a user device or the customer may include any of the contextual data 116 and the external data 120 that are related to the provision of telecommunication services to the user device by the wireless telecommunication network 102.

In some embodiments, the data collection module 212 may have the ability to directly query a user device for device information. In such embodiments, a query that is initiated by the data collection module 212 may be received by a device management application on the user device. In turn, the device management application may provide a response that includes the device information being queried. For example, the data collection module 212 may initiate a query to determine whether Wi-Fi calling is enabled on a user device, and the device management application may respond with the Wi-Fi calling enablement status of the user device. In at least one embodiment, a customer may have the ability to select whether device management application is to respond to queries from the data collection module 212 through a configuration setting of the application. In this way, the user may be given an opportunity to opt out of providing information to the data collection module 212. Accordingly, in some instances, the data collection module 212 may supplement a trouble report with relevant data from the operation databases 118 and/or the third-party databases 122.

The data collection module 212 may also generate a problem summary based on details in a trouble report and detail edits for the trouble report from a support person. The support person may enter the detail edits after communicating with the customer via a telephone call or an online chat session. The problem summary may include additional details regarding the service problem as revealed by the customer, highlighting of particular problem aspects, corrections to certain details of the trouble report, and/or so forth. For example, the detail edits may recite factual data about a service problem, such as date and time the service problem first occurred, the location of the affected user device when the service problem occurred, the duration of the service problem, the symptoms experienced by the customer with respect to the service problem, attempted solutions for the service problem, and/or so forth.

The issue classification module 214 analyze a trouble report from a customer to determine an underlying service issue that affects the customer. In various embodiments, the issue classification module 214 may use a machine learning algorithm to assign a service issue to the trouble report. The assignment may be performed based on descriptive words and/or phrases used by the customer in the trouble report, the relevant contextual data from the operation databases 118 and/or the third-party databases 122, and/or so forth. In some embodiments, the weight that is placed on the information provided by the customer in the trouble report by the issue classification module 214 is dependent on a proficiency rating of the customer. The proficiency rating may indicate an ability of the customer in accurately described a service problem that the customer encounters. For example, the customer may have previously submitted other trouble reports to the support service engine 104. Thus, a customer that in the past was more technically proficient at describing a service problem may have a higher proficiency rating, while a customer that in the past was less technically proficient at describing a service problem may have a lower proficiency rating.

As a result, when less weight is placed on the information provided by a customer in a trouble report, the issue classification module 214 may rely more on the relevant contextual information to determine the service issue that is associated with a trouble report. On the other hand, when more weight is placed on the information provided by a customer in a trouble report, the issue classification module 214 may rely more on the information provided by the customer than the relevant contextual information.

Once a service issue is identified, the selection module 216 may select a support person to assist a customer with a service issue based on the expertise ratings of available support persons with respect to the service issue. A support person may be available if a status of the support person shows that the support person is currently working and is not already helping another customer. The expertise ratings of the available support persons may be stored in the expertise database 124. Each support person may indicate that the person is available by logging into a worker status tracking function of the wireless telecommunication network 102. The worker status tracking function may also have the ability to track whether a support person is engaged in an online chat session or a telephone call with a customer based on information provided by the support applications running on the support terminals or voice call routing applications of the network 102.

In various embodiments, the selection module 216 may select an available support person with a highest expertise rating with respect to the service issue to assist the customer who reported the service issue via a trouble report. The highest expertise rating may indicate that the available support person has a higher amount of expertise with the service issue than one or more other available support persons with lower expertise ratings. In instances in which multiple support persons have the same highest expertise rating with respect to a service issue, the selection module 216 may select a support person with the expertise rating who has previously assisted the customer. However, if none of the multiple support persons have previously assisted the customer, the selection module 216 may randomly or in a round robin fashion select one of the support persons with the identical expertise rating to assist the customer.

Once a support person is selected, the selection module 216 may command the support session engine 106 to initiate an online chat session for the selected support person and the customer. The online chat session may enable the selected support person to exchange messages with the customer regarding the service issue. The chat session may be implemented using various protocols, such as the Session Initiation Protocol (SIP), SIP Instant Messaging and Presence Leveraging Extensions (SIMPLE), Application Exchange (APEX), Instant Messaging and Presence Protocol (IMPP), Extensible Messaging and Presence Protocol (XMPP), or other messaging protocols. Alternatively, the selection module 216 may command the support session engine 106 to place the selected support person into a telephone call with the customer.

In some embodiments, the selection module 216 may preferentially select an internal support person over an external support person to assist a customer when all other factors (e.g., availability, expertise rating, previous relationship with customer, etc.) are the same. However, when an internal support is not available, the selection module 216 may have the ability to outsource the assistance to an external support person. In such embodiments, the selection module 216 may determine whether there is an external support person available to handle the service issue for the customer within a predetermined time period. For instance, the predetermined time period may be selected via a service level agreement (SLA) to ensure that the customer is not forced to wait for an extended duration into order to receive support service. Since each of the external support persons are also graded with expertise ratings for service issues, the selection of a particular external support person to handle a service issue may proceed in an identical manner as for an internal support person.

The selection module 216 may further select an escalated support person in response to an indication that an initial support person is unable to resolve a service issue for a customer. The indication may be submitted by an initial support person or a customer. Upon receiving the indication, the selection module 216 may search the expertise database 124 for an available escalated support person that has equal or greater expertise with the service issue than the initial support person. Once an available escalated support person is found, the selection module 216 may command the support session engine 106 to place the escalated support person into an ongoing online chat session or telephone call that already exists between the initial support person and the customer. In this way, the escalated support person may join in or take over the resolution of the service issue for the customer.

In response, the support session engine 106 may save the session state information relevant to the communication exchange between the initial support person and the customer regarding the service issue. For example, the initial support person may be the initial support person 126. The session state information may include information from the trouble report, contextual data, external data, detail edits from the initial support person that are relevant to the service issue. The session state information may further include communications that are exchanged between customers and the initial support person. For communications in the form of text messages, the text messages may be stored as chat logs that are tagged with customer identifiers, customer service representative identifiers, dates and times, chat session identifiers, and/or other identification information. Such identification formation may be used to query and retrieve specific chat logs. In some embodiments, the support session engine 106 may use encryption or security algorithms to ensure that the exchanged text messages are secured from unauthorized viewing. For communications in the form of a telephone conversation, the support session engine 106 may use a speech-to-text engine to generate a transcript of the conversation. The transcript is then treated in the same manner as the text messages by the support session engine 106.

Subsequently, the support session engine 106 may forward the session state information to the escalated support person, such as the escalated support person 132. In turn, the escalated support person 132 may use a support application 134 to view the session state information 138. Following review of the session state information, the escalated support person 132 may use the support application 134 to indicate to the support session engine 106 that the new representative is ready to join or replace the initial support person 126 in the chat session or the telephone call.

The support session engine 106 may provide the escalated support person 132 with access to the chat session or the telephone call that is already in progress. In this way, the escalated support person 132 may seamlessly join or take over the chat session or the telephone call with the customer. In some instances, if the escalated support person 132 decides after reviewing the session state information to decline taking over the chat session, the escalated support person may send a decline indication to the support session engine 106. In alternative instances, the escalated support person may decline to join the chat session by failing to provide an acceptance indicator for the chat session in a predetermined amount of time. In turn, the support session engine 106 may initiate another search for an available and suitable escalated support person to join the chat session. However, such decline by the escalated support person may result in a decrease in the expertise rating of the escalated support person with respect to corresponding service issue. In some scenarios, a difficult service issue may be successively transferred to multiple escalated support persons. In such scenarios, the session state of the communications between each preceding support person may be saved and provided to each succeeding support person in a similar manner as described above.

The recommendation module 218 may use a machine learning-based recommendation algorithm to generate potential solutions for service issues that are classified from trouble reports. A potential solution for a service issue may be presented by a support person to a customer during a support session in the form of an online chat session or a telephone call. The machine learning-based recommendation algorithm may be a naïve Bayes algorithm, a Bayesian network algorithm, a decision tree algorithm, a neural network algorithm, a support vector machine, and/or so forth. In operation, the recommendation module 218 may use a machine learning algorithm to determine a root cause for a service issue. Subsequently, the recommendation module 218 may find one or more matching potential solutions for the root cause from a solutions database. For example, if the root cause of a service issue is the lack of network coverage, the potential solution for the root cause may be the activation of Wi-Fi calling and/or the installation of a Wi-Fi calling capable router. In another example, if the root cause of the service issue is user device software that is incompatible with the wireless telecommunication network 102, the potential solution may be an upgrade to the software of the user device.

In one implementation, the machine learning-based recommendation algorithm may be a Bayesian inference graph that stores multiple potential symptoms of multiple root causes as child nodes, in which each symptom is assigned a probability of corresponding to an associated root cause. In some instances, a child node for a symptom may have one or more additional child nodes that store sub-symptoms, in which the sub-symptoms have their respective probabilities corresponding to the parent symptom. By traversing the probabilities in the inference graph, a machine learning algorithm can receive a sub-symptom, find the likely parent symptom, and then proceed onto parent nodes until finding the likely root cause. Subsequently, the recommendation module 218 may parse out the trouble report details and the detail edits from a problem summary. The recommendation module 218 may modify one or more probabilities in the Bayesian inference graph based on an editing magnitude of the detail edits in the problem summary. The editing magnitude of the detail edits may be measured based on a number of words in the detail edits, in which a higher number of words equates to a greater editing magnitude, while a lower number of words equates to a lesser editing magnitude. Alternatively or concurrently, the recommendation module 218 may determine a contextual difference between the descriptors of the detail edits and/or a probabilistic relevance between the language in the trouble report and the detail edits using software algorithms. Accordingly, a higher contextual difference score or a lower relevance score may equate to a greater editing magnitude, while a lower contextual difference score or a higher relevance score may equate to a lesser editing magnitude. In turn, the editing magnitude of the detail edits may indicate the amount of actual correspondence between the original problem symptoms as reported in a trouble report and a potential root cause. For example, if the editing magnitude indicates that there is a lack of correspondence between a problem symptom and a first root cause, the recommendation module 218 may decrease a probability that associates the problem symptom and the first root cause. In another example, if the editing magnitude indicates that there is a strong correspondence between a problem symptom and a second root cause, the recommendation module 218 may increase a probability that associates the problem symptom and the second root cause.

Once the one or more probabilities in the Bayesian inference graph are modified, the recommendation module 218 may use a machine learning algorithm to search for the indicia of the symptoms in the Bayesian inference graph based on the details in the trouble report and the detail edits. During the search, the Bayesian inference graph may be evaluated by the machine learning algorithm to find a root cause to the service issue associated with the trouble report. The root cause and the one or more corresponding solutions may be provided by the recommendation module 218 to a support person for viewing.

The customer rating module 220 may rate the proficiency of a customer in describing a service issue based on an editing magnitude of the corresponding detail edits that are provided by a support person for an associated trouble report. In some instances, the editing magnitude of the detail edits may be measured based on a number of words in the detail edits, in which a higher number of words equates to a greater editing magnitude, while a lower number of words equates to a lesser editing magnitude. Accordingly, the editing magnitude may be directly translated into a corresponding proficiency rating for the customer.

In other instances, the recommendation module 218 may determine a contextual difference between the descriptors of the detail edits and/or a probabilistic relevance between the language in the trouble report and the detail edits using software algorithms. A software algorithm may generate a contextual difference score, in which a higher score indicates a higher contextual difference, while a lower contextual score indicates a lower contextual difference. Alternatively, a software algorithm may generate a relevance score, in which a higher score indicates a higher relevance between the language in the trouble report and the detail edits, while a lower score indicates a lower relevance. Accordingly, the customer rating module 220 may generate a proficiency rating that is inversely proportional to a contextual difference score or directly proportional to a relevance score. When there are multiple contextual difference scores or multiple relevance scores for a customer that are from multiple trouble reports, the customer rating module 220 may use an average of the multiple contextual difference scores or the multiple relevance scores to generate the proficiency rating for the customer in a similar manner.

The proficiency rating of a customer may be displayed by the customer rating module 220 to a support person, such as the initial support person 126. The proficiency rating may indicate to a support person the amount of reliance that the support person is to place in future trouble reports from the customer. This is because a customer who is able to accurately and proficiently describe a service issue is more helpful to a support person than a customer who has difficulty articulating the service issue that the customer is experiencing.

The support evaluation module 222 may adjust the expertise rating of a support person based on the performance of the support person in resolving service issues for customers. In various embodiments, the support evaluation module 222 may increase the expertise rating of a support person for a service issue upon a successful resolution of a service issue by the support person. In some instances, the increase may be an award of a predetermined number of expertise points for each time that the support person successfully resolves a particular service issue. In this way, the expertise rating of a support person for a particular service issue may increase as the support person accumulates more and more expertise points with respect to the particular service issue. In other embodiments, the accumulated expertise points may be translated into different level of expertise ratings according to predetermined standards. For example, an accumulation of 100 expertise points with respect to a service issue may increase an expertise rating of a support person from a lower level (e.g., expertise level one) to a higher level (e.g., expertise level two).

The support evaluation module 222 may decrease the expertise rating of a support person for a service issue when the support person is unable to resolve in service issue for a customer. The decrease may be implemented as the deduction of expertise points that a support person has with respect to a service issue. Accordingly, the deduction may directly decrease the expertise rating of the support person with respect to a service issue. Alternatively, the deduction may drop the expertise rating of the support person with respect to a service issue to a lower level when a predetermined amount of expertise points (e.g., 100 expertise points) is deducted. In additional embodiments, the support evaluation module 222 may award a support person one or more points for resolving a service issue, and no points if the support person is unable to resolve a service issue. The total number of points awarded is then divided by the number of service issues that are dealt with by the support evaluation module 222 to derive an averaged expertise rating for the support person over time. The support evaluation module 222 may determine that a support person is unable to resolve a service issue under several instances. One instance is when the support person indicates via a support application that the support person is unable to resolve a service issue for a customer. Another instance is when the support evaluation module 222 determines that a follow up trouble report for the same service issue is received from a customer.

The support evaluation module 222 may also configure the machine learning algorithms and the weights assigned to the inputs of support persons based on the performance of the support persons. In one instance, when the support evaluation module 222 determines that a follow up trouble report for the same service issue is received from a customer, the module may decrease a probability stored in a Bayesian inference graph that a previously selected root cause for the service issue is related to the symptoms of the service issue. This is because the previously selected root cause, as determined by the recommendation module 218 for the service issue, is assumed to be incorrect and failed to solve the service issue because the customer returned with the same service issue.

The support evaluation module 222 may also receive an indication from an escalated support person that indicates whether a service issue is correctly routed to the escalated support person from an initial support person. For example, the escalated support person may indicate that the service issue was incorrectly routed when, following a discussion with the customer, the escalated support person determines that the customer actually has a different service issue than indicated by the received session state information. This service issue mismatch may cause difficulty for the escalated support person as the escalated support person may have no expertise with the actual service issue. The escalated support person may provide such an indication via an option provided by a support application.

Accordingly, if the support evaluation module 222 receives an indication that the service issue was not correctly routed, the module may decrease a weight assigned to future detail edits that originate from the initial support person. In other words, the support evaluation module 222 may modify the weight so that the selection module 216 may place less reliance on future detail edits provided by the initial support person during the determination of the service issue for the troubleshoot. This is because the current detail edits of the initial support person may have lead the issue classification module 214 to determine that customer is requesting assistance with the wrong service issue. Accordingly, the issue classification module 214 may rely comparatively more on other sources of data, such as the trouble report details, the contextual data 116, and/or the external data 120, than the detail edits to determine a service issue that corresponds to a future trouble report.

On the other hand, if the support evaluation module 222 receives an indication that the service issue was correctly routed, the module may increase a weight assigned to future detail edits that originate from the initial support person. This is because the detail edits of the initial support person for a current service issue correctly led the issue classification module 214 to determine that the customer is requesting assistance with the right service issue. Accordingly, the issue classification module 212 may rely comparatively more on the detail edits than other sources of data, such as the trouble report details, the contextual data 116, and/or the external data 120 to determine a service issue that corresponds to a future trouble report. In this way, the increase or decrease in the weight assigned to the future detail edits may affect a degree of reliance that the issue classification module 214 places on future detail edits in determining a service issue that corresponds to a future trouble report.

The support evaluation module 222 may further receive performance evaluations of the support persons directly from customers. For example, at the end of each online chat session or telephone call session, the customer may be prompted to rate their experience with the support person as positive or negative. Thus, a positive rating may increase the expertise rating of the support person with respect to the service issue that is discussed during the session, while a negative rating may decrease the expertise rating of the support person with respect to the service issue.

The support evaluation module 222 may further generate evaluation data that summarizes the issue resolution performance of an external support person. The evaluation data may show the issue resolution rate, the average resolution time, the average customer wait time before action, the customer satisfaction rating, the resolution vs. escalation ratio, and/or other performance categories for the external support person. Accordingly, the support evaluation module 222 may make a recommendation as to whether to continue use the external support person based on the evaluation data. The recommendation may be presented for viewing by a supervisor of the external support person at the wireless telecommunication carrier. For example, the support evaluation module 222 may recommend continue use of the external support person when the performance of the external support person in a predetermined minimal number of performance categories meet their corresponding minimal performance requirements. Otherwise, the support evaluation module 222 may recommend discontinue the use of the external support person.

Moreover, in some instances, the support evaluation module 222 may further recommend offering the external support person an opportunity to become an internal support person, e.g., offering the external support person employment. In order to do so, the support evaluation module 222 may determine whether the performance of the external support person in an extra set of predetermined minimal number of performance categories meet their corresponding minimal performance requirements, in which the extra set are in additional to the sets used to determine whether to continue use the external support person.

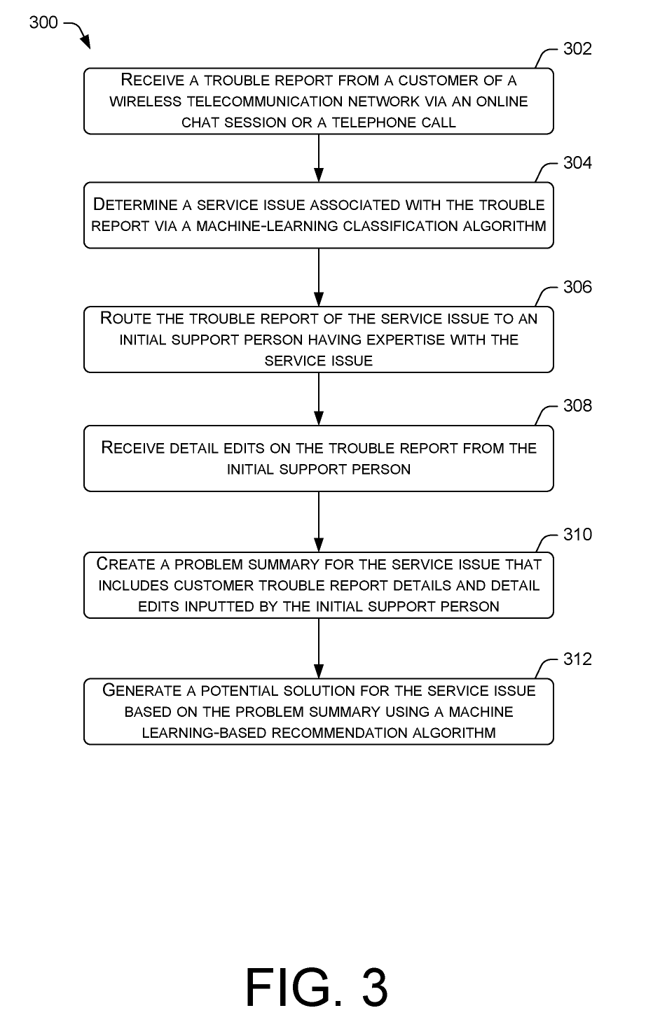

The data store 224 may store information that are used or processed by the support service engine 104. The data store 224 may include one or more databases, such as relational databases, object databases, object-relational databases, and/or key-value databases. The data store 224 may provide storage of the machine learning algorithms 226 that are used by the support service engine. The data store 224 may further store a solutions database 228, a session state database 230, and the expertise database 124. The solutions database 228 may provide solutions for root causes that are identified by the recommendation module 218. The session state database 230 may store the session states that are generated for the escalation of support sessions to new support persons. Additional details regarding the functionalities of the support service engine 104 are discussed in the context of FIGS. 3-9. Thus, the support service engine 104 may include other modules and databases that perform the functionalities described in the context of these figures.

### Example Processes

FIGS. 3-9 present illustrative processes 300-900 for deploying machine learning-based customer care routing. Each of the processes 300-900 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300-900 are described with reference to the architecture 100 of FIG. 1.

FIG. 3 is a flow diagram of an example process 300 for determining a service issue for a trouble report from a customer and routing the customer to an expert support person. At block 302, the support service engine 104 may receive a trouble report from a customer of a wireless telecommunication network 102 via an online chat session or a telephone call. In various embodiments, a customer may use a user device to place a telephone support call to a customer care phone number of the wireless telecommunication network 102. In turn, the support service engine 104 may prompt the customer to leave a trouble report in the form of a brief audio recording that describes a wireless telecommunication service problem encountered by the customer. Alternatively, the customer 110 may use a customer chat application on the user device to initiate a support chat session with the support service engine 104.

At block 304, the support service engine 104 may determine a service issue associated with the trouble report via a machine learning classification algorithm. In various embodiments, the machine learning classification algorithm may match specific words or phrases that the customer used in the trouble report to a specific service issue. In some embodiments, the machine-learning classification algorithm may also use contextual data 116 from the operation database 118 and/or external data 120 from the third-party databases 122 to determine the actual issue encountered by the customer who provided the trouble report.

At block 306, the support service engine 104 may route the trouble report of the service issue to an initial support person having expertise with the service issue. In various embodiments, the support service engine 104 may select an available support person with a highest expertise rating with respect to the service issue to assist the customer who reported the service issue via a trouble report. In instances in which multiple support persons have the same expertise rating with respect to a service issue, the support service engine 104 may select a support person with the expertise rating who has previously assisted the customer. However, if none of the multiple support persons with the same expertise rating have previously assisted the customer, the support service engine 104 may randomly or in a round robin fashion select one of the support persons with the expertise rating to assist the customer.

At block 308, the support service engine 104 may receive detail edits on the trouble report from the initial support person. In various embodiments, the initial support person may make detail edits to the trouble report of the customer based on the obtained knowledge and/or experience of the initial support person. For example, the detail edits may recite factual data about a service problem, such as date and time the service problem first occurred, the location of the affected user device when the service problem occurred, the duration of the service problem, the symptoms experienced by the customer with respect to the service problem, attempted solutions for the service problem, and/or so forth.

At block 310, the support service engine 104 may create a problem summary for the service that includes customer trouble report details and detail edits inputted by the initial support person. In various embodiments, the problem summary may include additional details regarding the service problem as revealed by the customer, highlighting of particular problem aspects, corrections to certain details of the trouble report, and/or so forth.

At block 312, the support service engine 104 may generate a potential solution for the service issue based on the problem summary using a machine learning-based recommendation algorithm. In various embodiments, the machine learning algorithms may include a naïve Bayes algorithm, a Bayesian network algorithm, a decision tree algorithm, a neural network algorithm, and/or so forth. In operation, the support service engine 104 may use a machine learning algorithm to determine a root cause for a service issue. Subsequently, the support service engine 104 may find one or more matching potential solutions for the root cause from a solutions database.

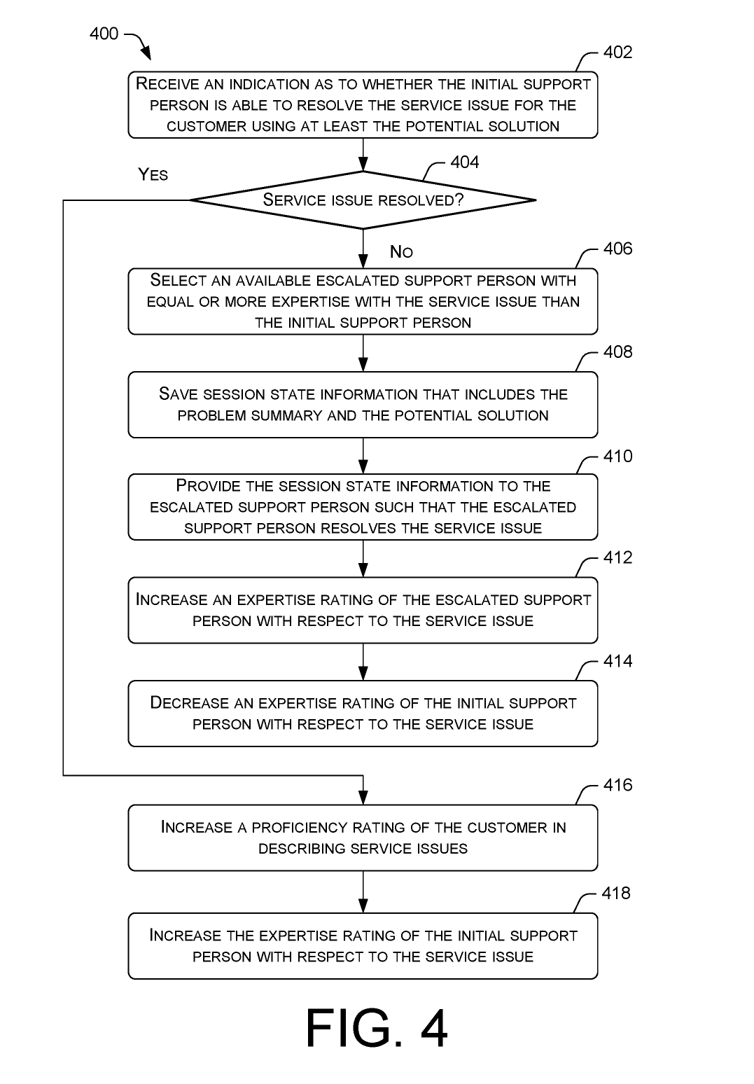

FIG. 4 is a flow diagram of an example process 400 for increasing or decreasing an expertise rating of an initial support person with respect to a service issue based on the whether the initial support person is able to resolve the service issue for the customer. The process 400 may be a continuation of the process 300 described in FIG. 3. At block 402, the support service engine 104 may receive an indication as to whether the initial support person is able to resolve the service issue for the customer using at least the potential solution generated by the support service engine 104. In various embodiments, the initial support person may either provide an indication that the potential solution resolved the service issue or that the initial support person failed to resolve the service issue using the potential solution. In some instances, the initial support person may also use other knowledge or expertise along with the potential solution to resolve the service issue for the customer. Accordingly, at decision block 404, if the support service engine 104 determines that the service issue is not resolved (“no” at decision block 404), the process 400 may proceed to block 406.

At block 406, the support service engine 104 may select an escalated support person with equal or more expertise than the initial support person with the service issue to resolve the service issue for the customer. In various embodiments, the support service engine 104 may use the expertise ratings in the expertise database 124 for an available escalated support person that has equal or greater expertise with the service issue than the initial support person. Once an available escalated support person is found, the selection module 216 may command the support session engine 106 to place the escalated support person into an ongoing online chat session or telephone call that already exists between the initial support person and the customer.

At block 408, the support service engine 104 may save session state information that includes the problem summary and the potential solution. In various embodiments, the session state information may include information from the trouble report, contextual data, external data, detail edits from the initial support person that are relevant to the service issue. The session state information may further include communications that are exchanged between customers and the initial support person.

At block 410, the support service engine 104 may provide the session state information to the escalated support person to resolve the service issue for the customer. In various embodiments, the support session engine 106 may provide the escalated support person with access to the chat session or the telephone call that is already in progress. In this way, the escalated support person may seamlessly join or take over the chat session or the telephone call with the customer.

At block 412, the support service engine 104 may increase an expertise rating of the escalated support person with respect to the service issue. In some embodiments, the increase may be an award of a predetermined number of expertise points. In this way, the expertise rating of the escalated support person for the service issue may increase as the support person accumulates expertise points with respect to the particular service issue. In at least one embodiment, the accumulated expertise points may be translated into a higher level of expertise rating according to a predetermined standard (e.g., 100 expertise points).

At block 414, the support service engine 104 may decrease an expertise rating of the initial support person with respect to the service issue. In some embodiments, the decrease may be implemented as the deduction of expertise points that the initial support person has with respect to a service issue. Accordingly, the deduction may directly decrease the expertise rating of the initial support person with respect to a service issue. Alternatively, the deduction may drop the expertise rating of the initial support person with respect to the service issue to a lower level when a predetermined amount of expertise points (e.g., 100 expertise points) is deducted.

Returning to decision block 404, if the support service engine 104 determines that the service issue is resolved (“yes” at decision block 404), the process 400 may proceed to block 416. At block 416, the support service engine 104 may increase a proficiency rating of the customer in describing issues. The proficiency rating may indicate an ability of the customer in accurately described a service problem that the customer encounters. Thus, a customer that in the past was more technically proficient at describing a service problem may have a higher proficiency rating, while a customer that in the past was less technically proficient at describing a service problem may have a lower proficiency rating. At block 418, the support service engine 104 may further increase the expertise rating of the initial support person with respect to the service issue.

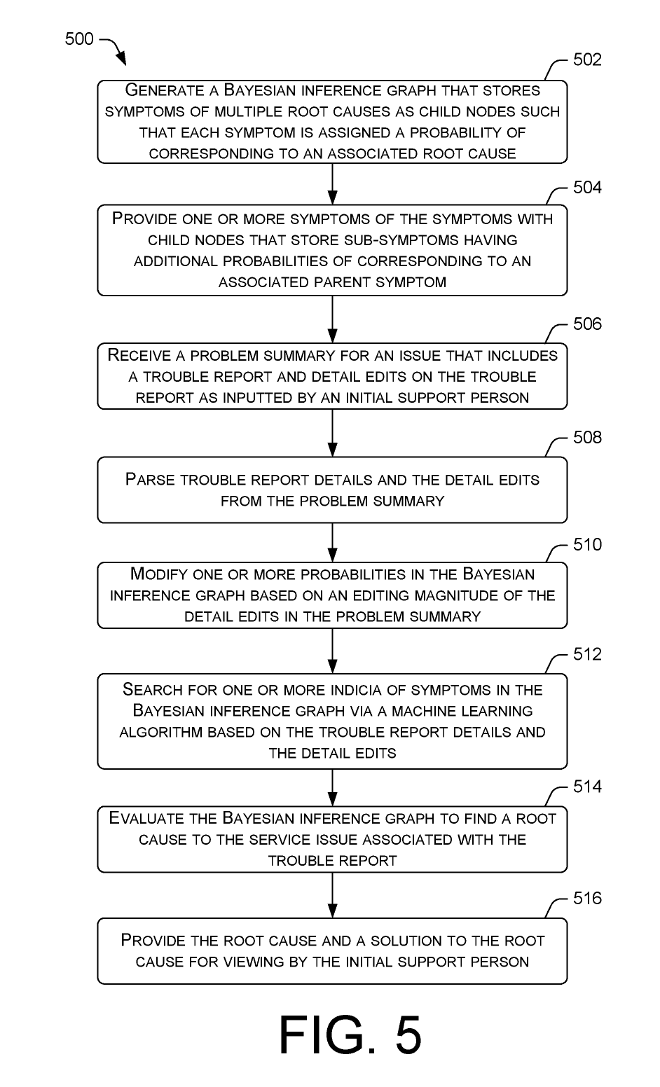

FIG. 5 is a flow diagram of an example process 500 for using a machine-learning algorithm in the form of a Bayesian inference graph to determine a root cause of a service issue that is associated with a customer trouble report. At block 502, the support service engine 104 may generate a Bayesian inference graph that stores symptoms of multiple root causes as child nodes such that each symptom is assigned a probability of corresponding to an associated root cause. At block 504, the support service engine 104 may provide one or more symptoms of symptoms with child nodes that store sub-symptoms having additional probabilities of corresponding to an associated parent symptom. At block 506, the support service engine 104 may receive a problem summary for an issue that includes a trouble report and detail edits on the trouble report as inputted by an initial support person.

At block 508, the support service engine 104 may parse trouble report details and the detail edits from the problem summary. In various embodiments, the parsing may include evaluating the magnitude of the details edits. In various embodiments, the editing magnitude of the detail edits may be measured based on a number of words in the detail edits. Alternatively or concurrently, the editing magnitude may be determined based on a contextual difference between the descriptors of the detail edits, a probabilistic relevance between the language in the trouble report and the detail edits, and/or so forth. At block 510, the support service engine 104 may modify one or more probabilities in the Bayesian inference graph based the editing magnitude of the detail edits in the problem summary. In various embodiments, the editing magnitude of the detail edits may indicate the amount of actual correspondence between an original problem symptom as reported in a trouble report and a potential root cause.

At block 512, the support service engine 104 may search for one or more indicia of symptoms in the Bayesian inference graph via a machine learning algorithm based on the trouble report details and the detail edits. At block 514, the search for the indicia may evaluate the Bayesian inference graph to find a root cause to the service issue associated with the trouble report.

At block 516, the support service engine 104 may provide the root cause and a solution to the root cause for viewing by the initial support person. In various embodiments, the support service engine 104 may find one or more matching potential solutions for the root cause from a solutions database, such as the solutions database 228.

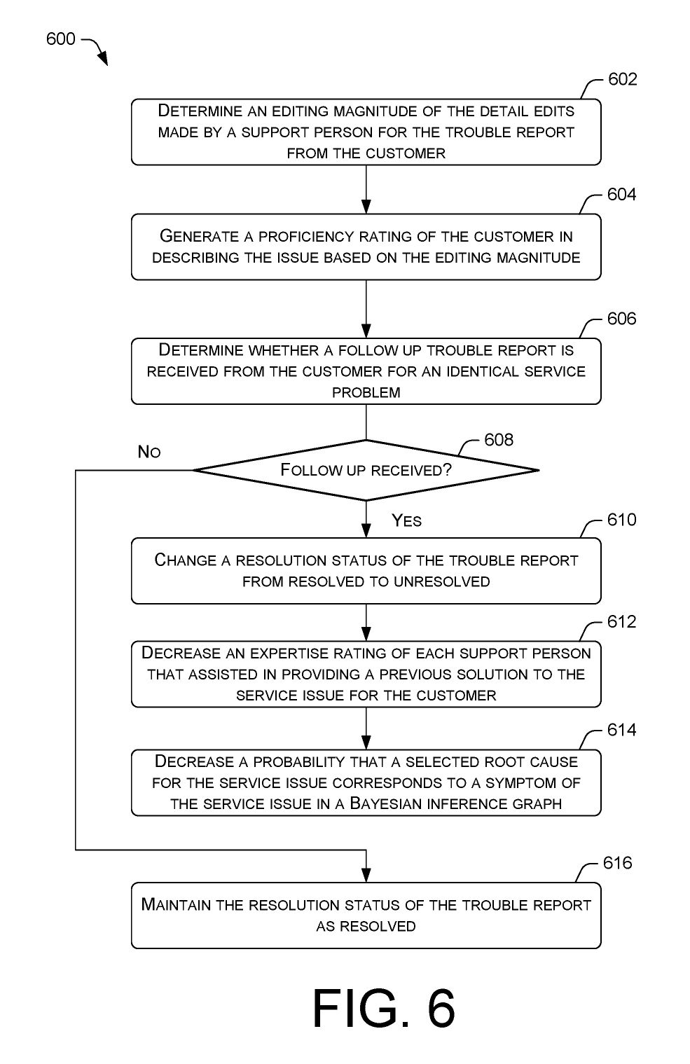

FIG. 6 is a flow diagram of an example process 600 for adjusting the ratings of customers and support persons based on the interactions between the customer and one or more support persons of the wireless telecommunication carrier. At block 602, the support service engine 104 may determine an editing magnitude of the detail edits made by a support person for the trouble report from the customer. In various embodiments, the parsing may include evaluating the magnitude of the details edits. The editing magnitude of the detail edits may be measured based on a number of words in the detail edits. Alternatively or concurrently, the editing magnitude may be determined based on a contextual difference between the descriptors of the detail edits, a probabilistic relevance between the language in the trouble report and the detail edits, and/or so forth.

At block 604, the support service engine 104 may generate a proficiency rating of the customer in describing the issue based on the editing magnitude. In various embodiments, the proficiency rating for the customer may be inversely proportional to a context difference score or a relevance score that is derived from the editing magnitude of the edit details for the trouble report.

At block 606, the support service engine 104 may determine whether a follow up trouble report is received from the customer. The follow up trouble report is a report that initiated by the customer for the same service problem as a previous trouble report. The follow up trouble report may trigger an assumption by the support service engine 104 that one or more previous solution provided by at least one support person to the customer in a prior support communication did not actually solve the service problem. Accordingly, at decision block 608, if the support service engine 104 determines that the follow up trouble report is received (“yes” at decision block 608), the process 600 may proceed to block 610. At block 610, the support service engine 104 may change a resolution status of the trouble report from resolved to unresolved.

At block 612, the support service engine 104 may decrease an expertise rating of each support person that assisted in providing a previous solution to the service issue for the customer. In various embodiments, the decrease may be implemented as a deduction of expertise points that the initial support person has with respect to a service issue. Accordingly, the deduction may directly decrease the expertise rating of the initial support person with respect to a service issue. Alternatively, the deduction may drop the expertise rating of the initial support person with respect to the service issue to a lower level when a predetermined amount of expertise points (e.g., 100 expertise points) is deducted.

At block 614, the support service engine 104 may decrease a probability that a selected root cause for the service issue corresponds to a symptom of the service issue in a Bayesian inference graph. This is because the selected root cause may be assumed to be incorrectly selected as the one or more solutions provided for the selected root cause failed to solve the service issue.

Returning to decision block 608, if the support service engine 104 determines that no follow up trouble report is received (“no” at decision block 608), the process 600 may proceed to block 616. At block 616, the support service engine 104 may maintain the resolution status of the trouble report as resolved.

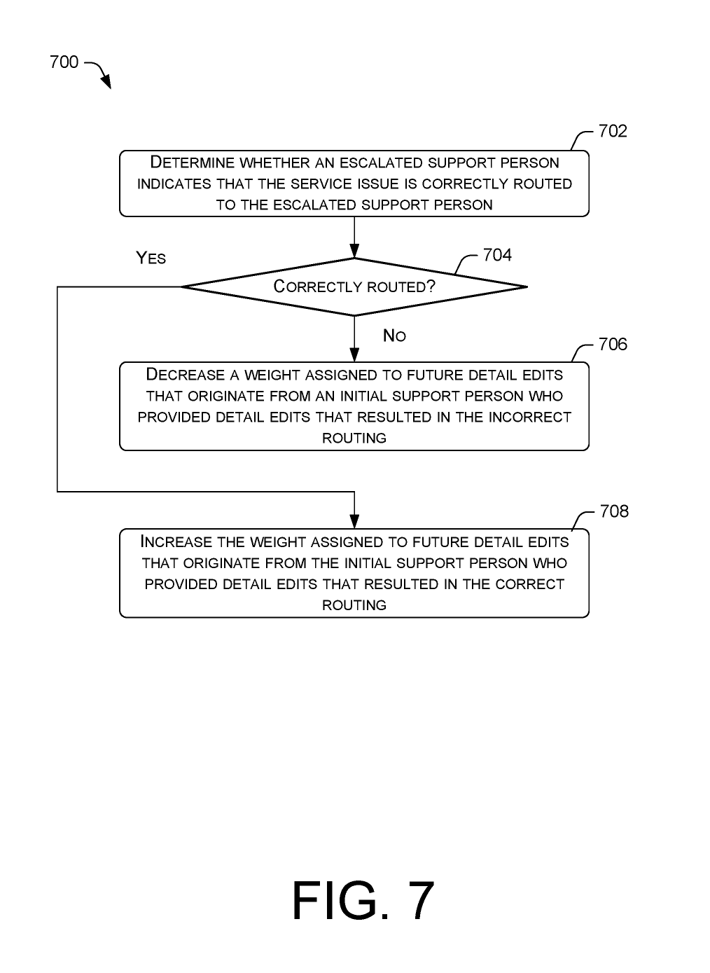

FIG. 7 is a flow diagram of an example process 700 for weighting the detail edits generated by an initial support person for the selection of an escalated support person. At block 702, the support service engine 104 may determine whether an escalated support person indicates that the service issue is correctly routed to the escalated support person. For example, the escalated support person may indicate that the service issue was incorrectly routed when, following a discussion with the customer, the escalated support person determines that the customer actually has a different service issue than indicated by the received session state information. Otherwise, the escalated support person may indicate that the service issue is correctly routed to the escalated support person.

At decision block 704, if the support service engine 104 determines that the service issue is incorrectly routed (“no” at decision block 704), the process 700 may proceed to block 706. At block 706, the support service engine 104 may decrease a weight assigned to future detail edits that originate from an initial support person who provided detail edits that resulted in the incorrect routing. However, if the support service engine 104 determines that the service issue is correctly routed (“yes” at decision block 704), the process 700 may proceed to block 708. At block 708, the support service engine 104 may increase the weight assigned to the future detail edits that originate from the initial support person who provided detail edits that resulted in the correct routing.

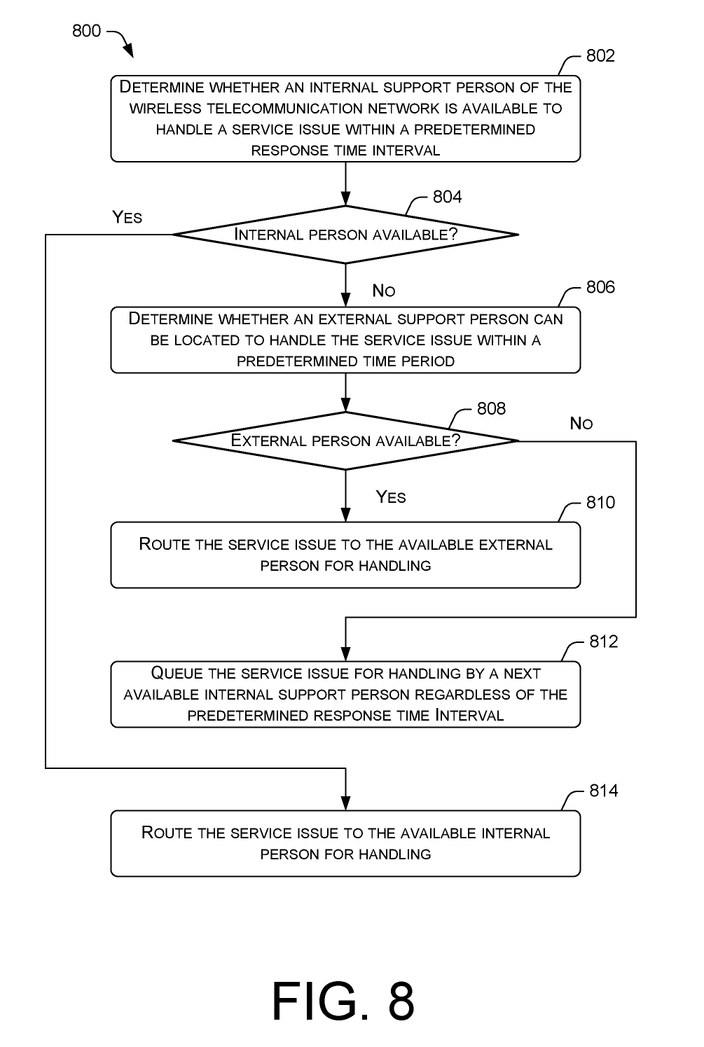

FIG. 8 is a flow diagram of an example process 800 for routing a service issue to an internal support person or an external support person for resolution. At block 802, the support service engine 104 may determine whether an internal support person of the wireless telecommunication network 102 is available to handle a service issue within a predetermined response time interval. At decision block 804, if the support service engine 104 determines that the internal person is not available (“no” at decision block 804), the process 800 may proceed to block 806. At block 806, the support service engine 104 may determine whether an external support person can be located to handle the service issue within a predetermined time period. In some embodiments, the predetermined time period may be longer in duration than the predetermined response time interval.

Thus, at decision block 808, if the support service engine 104 determines that an external person is available (“yes” at decision block 808), the process 800 may proceed to block 810. At block 810, the support service engine 104 may route the service issue to the available external person for handling. However, if the support service engine 104 determines that no external person is available (“no” at decision block 808), the process 800 may proceed to block 812. At block 812, the support service engine 104 may queue the service issue for handling by a next available internal support person regardless of the predetermined response time interval.

Returning to decision block 804, if the support service engine 104 determines that the internal person is available (“yes” at decision block 804), the process 800 may proceed to block 814. At block 814, the support service engine 104 may route the service issue to the available internal person for handling.

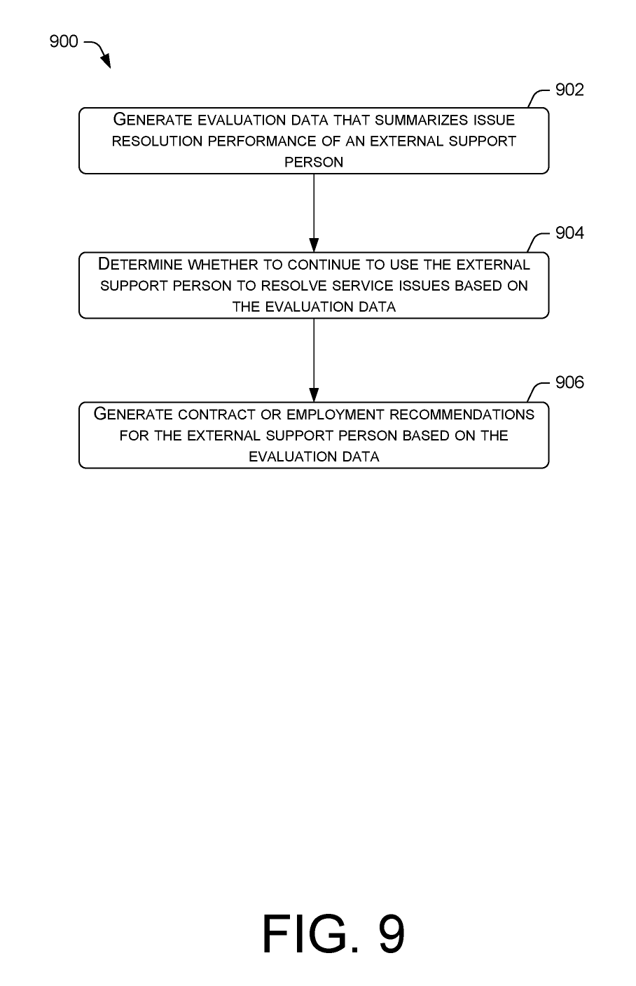

FIG. 9 is a flow diagram of an example process 900 for using the performance of an external support person in resolving service issues to determine a status of the external support person with the wireless telecommunication carrier. At block 902, the support service engine 104 may generate evaluation data that summarizes issue resolution performance of an external support person. In various embodiments, the evaluation data may show the issue resolution rate, the average resolution time, the average customer wait time before action, the customer satisfaction rating, the resolution vs. escalation ratio, and/or other performance categories for the external support person.

At block 904, the support service engine 104 may determine whether to continue to use the external support person to resolve issue based on the evaluation data. In various embodiments, the support service engine 104 may recommend continue use of the external support person when the performance of the external support person in a predetermined minimal number of performance categories meet their corresponding minimal performance requirements. Otherwise, the support service engine 104 may recommend discontinue the use of the external support person.

At block 906, the support service engine 104 may generate contract or employment recommendations for the external support person based on the evaluation. For example, the support service engine 104 may determine whether the performance of the external support person in an extra set of predetermined minimal number of performance categories meet their corresponding minimal performance requirements, in which the extra set are in additional to the sets used to determine whether to continue use the external support person.

The use of machine learning-based customer care routing may increase the likelihood that a customer who is experiencing a service issue is assisted by a support person that has expertise with the service issue. Further, the use of machine-learning-based customer caring routing may classify the support persons of the wireless telecommunication carrier according to their expertise rather than their other attributes (e.g., physical location, assigned department, etc.). By assigning different experts to resolve service issues that are reported by a customer, the customer is essentially provided with a team of experts that are able to deliver the most suitable assistance to the customer regarding of the nature of the service issues that are encountered by the customer. Thus, the techniques may increase customer satisfaction and customer retention by providing attentive customer care service to the customer.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
determining a service issue associated with a trouble report via a machine learning classification algorithm, the trouble report being received from a customer of a wireless telecommunication network via on online chat session or a telephone call;
routing the trouble report of the service issue to a support person, the support person being selected from multiple available support persons based at least on the support person having a higher level of expertise with the service issue than one or more other available support persons;
receiving detail edits on the trouble report from the support person, the detail edits provided by the support person based at least on knowledge obtained from the customer during the online chat session or the telephone call;
creating a problem summary for the service issue that includes trouble report details from the trouble report and detail edits provided by the support person; and
generating a potential solution for the service issue based on the problem summary using a machine learning-based recommendation algorithm.

2. The one or more non-transitory computer-readable media of claim 1, wherein the acts further comprise:
receiving an indication that the support person is unable to resolve the service issue for the customer using at least the potential solution;
selecting an escalated support person with equal or more expertise with the service issue as the support person to resolve the service issue for the customer;
saving session state information that includes the problem summary and the potential solution;
providing the session state information to the escalated support person such that the escalated support person resolves the service issue for the customer;
increasing, by support evaluation computer-executable instructions that are implemented to evaluate support person performance, an expertise rating of the escalated support person with respect to the service issue following a resolution of the service issue by the escalated support person; and
decreasing, by the support evaluation computer-executable instructions that are implemented to evaluate support person performance, an expertise rating of the support person with respect to the service issue.

3. The one or more non-transitory computer-readable media of claim 2, wherein the acts further comprise:
determining whether the escalated support person indicates that the service issue is correctly routed to the escalated support person;
decreasing a weight assigned to additional detail edits that originate from the support person who provided the detail edits in response to an indication from the escalated support person that the service issue is incorrectly routed; and
increasing the weight assigned to the additional detail edits that originate from the support person who provided the detail edits in response to an indication from the escalated support person that the service issue is correctly routed,
wherein the weight affects a degree of reliance on the additional detail edits from the support person in determining an additional service issue associated with an additional trouble report via the machine learning classification algorithm.

4. The one or more non-transitory computer-readable media of claim 1, wherein the acts further comprise:
receiving an indication that the support person resolved the service issue for the customer using at least the potential solution; and
increasing at least one of a proficiency rating of the customer in describing service issues in trouble reports in response to the indication or an expertise rating of the support person with respect to the service issue in response to the indication.

5. The one or more non-transitory computer-readable media of claim 1, wherein the determining includes determining the service issue based on trouble report details in the trouble report and at least one of contextual data from an operation database of the wireless telecommunication network or external data from a third-party database.

6. The one or more non-transitory computer-readable media of claim 5, wherein the contextual data includes at least one of network contextual information regarding technical and operational status of the wireless telecommunication network, device contextual information regarding technical capabilities, feature settings, and operational status of a user device, account contextual information that includes account details associated with the user device, and wherein the external data includes social media data.

7. The one or more non-transitory computer-readable media of claim 1, wherein the generating the potential solution includes:
generating a Bayesian inference graph that stores a plurality of symptoms of multiple root causes as child nodes such that each symptom is assigned a probability of corresponding to an associated root cause;
providing one or more symptoms of the plurality of symptoms with child nodes that store sub-symptoms having additional probabilities of corresponding to associated parent nodes;
receiving a problem summary for an issue that includes the trouble report and detail edits on the trouble report as provided by the support person;
parsing the trouble report details of the trouble reports and detail edits from the problem summary;
modifying one or more probabilities in the Bayesian inference graph based on an editing magnitude of the detail edits in the problem summary;
searching for one or more indicia of symptoms in the Bayesian inference graph via a machine learning algorithm based on the trouble report details and the detail edits;
evaluating the Bayesian inference graph to find a root cause to the service issue associated with trouble report; and
providing the root cause and a solution to the root cause for viewing by the support person.

8. The one or more non-transitory computer-readable media of claim 7, wherein the acts further comprise:
receiving a follow up trouble report from the customer for an identical service problem as the trouble report; and
decreasing a probability that the root cause for the service issue corresponds to a symptom of the service issue in the Bayesian inference graph.

9. The one or more non-transitory computer-readable media of claim 1, wherein the acts further comprise:
determining an editing magnitude of the detail edits made by the support person for the trouble report from the customer; and
generating a proficiency rating of the customer in describing service issues in trouble reports based on the editing magnitude.

10. The one or more non-transitory computer-readable media of claim 1, wherein the acts further comprise:
receiving a follow up trouble report from the customer for an identical service problem as the trouble report; and
decreasing an expertise rating of the support person or an escalated support person that assisted in providing a previous solution to the service issue for the customer.

11. The one or more non-transitory computer-readable media of claim 1, wherein the routing the trouble report of the service issue includes:
determining whether an internal support person of the wireless telecommunication network is available to handle the service issue within a predetermined response time interval;
routing the service issue to the internal support person in response to determining that the internal support person is available during the predetermined response time interval;
routing the service issue to an external support person in response to determining that the internal support person is unavailable within the predetermined response time interval and the external support person is available within a predetermined time period, the predetermined time period being longer in duration than the predetermined response time interval; and
queuing the service issue for handling by a next available internal support person in response to determining that the internal support person is unavailable within the predetermined response time interval and the external support person is unavailable within a predetermined time period.

12. The one or more non-transitory computer-readable media of claim 11, wherein the internal support person is employed by the wireless telecommunication network, and the external support person is a third-party vendor, a third-party contractor, or a crowd-sourced expert.

13. The one or more non-transitory computer-readable media of claim 11, wherein the acts further comprise:
generating evaluation data that summarizes issue resolution performance of the external support person; and
determining to continue to use the external support person to resolve service issues in response to the evaluation data showing that a performance of the external support person in one or more performance categories meet one or more corresponding minimal performance requirements.

14. The one or more non-transitory computer-readable media of claim 13, wherein the acts further comprise generating contract or employment recommendations for the external support person based on the evaluation data.

15. A computer-implemented method, comprising:
receiving, at one or more computing devices, a trouble report from a customer of a wireless telecommunication network via on online chat session or a telephone call;
determining, at the one or more computing devices, a service issue associated with the trouble report via a machine learning classification algorithm based on trouble report details in the trouble report and at least one of contextual data from an operation database of the wireless telecommunication network or external data from a third-party database;
routing, at the one or more computing devices, the trouble report of the service issue to a support person, the support person being selected from multiple available support persons based at least on the support person having a higher level of expertise with the service issue than one or more other available support persons;
receiving, at the one or more computing devices, detail edits on the trouble report from the support person, the detail edits provided by the support person based at least on knowledge obtained from the customer during the online chat session or the telephone call;
creating, at the one or more computing devices, a problem summary for the service issue that includes trouble report details from the trouble report and detail edits provided by the support person; and
generating, at the one or more computing devices, a potential solution for the service issue based on the problem summary using a machine learning-based recommendation algorithm.

16. The computer-implemented method of claim 15, wherein the contextual data includes at least one of network contextual information regarding technical and operational status of the wireless telecommunication network, device contextual information regarding technical capabilities, feature settings, and operational status of a user device, account contextual information that includes account details associated with the user device, and wherein the external data includes social media data.

17. The computer-implemented method of claim 15, further comprising:
receiving an indication that the support person is unable to resolve the service issue for the customer using at least the potential solution;
selecting an escalated support person with equal or more expertise with the service issue as the support person to resolve the service issue for the customer;
saving session state information that includes the problem summary and the potential solution;
providing the session state information to the escalated support person such that the escalated support person resolves the service issue for the customer;
increasing an expertise rating of the escalated support person with respect to the service issue following a resolution of the service issue by the escalated support person; and
decreasing an expertise rating of the support person with respect to the service issue.

18. The computer-implemented method of claim 15, further comprising:
receiving a positive rating or a negative rating for a particular support person from the customer following an end of the online chat session or the telephone call that involves a service issue;
increasing an expertise rating of the particular support person with respect to the service issue in response to the positive rating; and
decreasing an expertise rating of the particular support person with respect to the service issue in response to the negative rating.

19. The computer-implemented method of claim 15, further comprising:
determining whether an escalated support person indicates that the service issue is correctly routed to the escalated support person;
decreasing a weight assigned to additional detail edits that originate from the support person who provided the detail edits in response to an indication from the escalated support person that the service issue is incorrectly routed; and
increasing the weight assigned to the additional detail edits that originate from the support person who provided the detail edits in response to an indication from the escalated support person that the service issue is correctly routed,
wherein the weight affects a degree of reliance on the additional detail edits from the support person in determining an additional service issue associated with an additional trouble report via the machine learning classification algorithm.

20. A system, comprising:
one or more processors; and
memory including a plurality of computer-executable components that are executable by the one or more processors to perform a plurality of actions, the plurality of actions comprising:
receiving a trouble report from a customer of a wireless telecommunication network via an online chat session between the customer and a support person;
determining a service issue associated with the trouble report via a machine learning classification algorithm;
routing the trouble report of the service issue to a support person, the support person being selected from multiple available support persons based at least on the support person having a higher level of expertise with the service issue than one or more other available support persons;
receiving detail edits on the trouble report from the support person, the detail edits provided by the support person based at least on knowledge obtained from the customer during the online chat session;
creating a problem summary for the service issue that includes trouble report details from the trouble report and detail edits provided by the support person;
generating a potential solution for the service issue based on the problem summary using a machine learning-based recommendation algorithm
receiving an indication that the support person resolved the service issue for the customer using at least the potential solution;
increasing a proficiency rating of the customer in describing service issues in trouble reports in response to the indication; and
increasing an expertise rating of the support person with respect to the service issue in response to the indication.
